(19) United States
(12) Patent Application Publication
(10) Pub. No.: US 2026/0070081 A1
(43) Pub. Date: Mar. 12, 2026

(54) APPARATUS AND METHOD FOR DRYING BATTERY ELECTRODES

(71) Applicant: SK ON CO., LTD., Seoul (KR)

(72) Inventors: Yeon Woo SEO, Daejeon (KR); Yang Hyun KIM, Daejeon (KR); Do Eon LEE, Daejeon (KR); Tae Hui LEE, Daejeon (KR)

(21) Appl. No.: 19/289,116

(22) Filed: Aug. 4, 2025

(30) Foreign Application Priority Data
Sep. 6, 2024 (KR) 10-2024-0121252

(51) Int. Cl. B05C 9/14; H01M 4/04

(52) U.S. Cl. CPC B05C 9/14; H01M 4/0404

(57) ABSTRACT

An apparatus for drying a battery electrode includes a drying portion for drying a coated electrode sheet; an auxiliary heater portion disposed in the drying portion and configured to dry the coated electrode sheet; and a control unit configured to control turning-off driving of the auxiliary heater portion in response that a coating stop is initiated for a foil connection portion of an electrode sheet to be coated, in which a prior foil and a subsequent foil are connected to each other, and to control redriving of the auxiliary heater portion in response that the foil connection portion passes through the drying portion and a coating restart is initiated.

### CROSS-REFERENCE TO RELATED APPLICATION(S)

This application claims benefit of priority to Korean Patent Application No. 10-2024-0121252 filed on Sep. 6, 2024 in the Korean Intellectual Property Office, the disclosure of which is incorporated herein by reference in its entirety.

### TECHNICAL FIELD

The present disclosure generally relates to an apparatus and a method for drying battery electrodes.

### BACKGROUND

Generally, a process of manufacturing a battery may include a process of producing an electrode, including a process of coating a battery electrode, as a process before a battery electrode is connected to a battery cell.

Generally, a process of coating a battery electrode may include a coating process of coating a portion of an electrode foil with an electrode material (e.g., slurry), and a process of drying an electrode sheet, including an electrode coating portion in which a portion is coated with an electrode material and an electrode uncoating portion in which another portion is uncoated, after the coating process. Here, the electrode sheet may refer to an electrode foil used in the process of coating a battery electrode.

Before the coating process, a foil connection operation may be performed to connect a rear end portion of a preceding electrode foil to a front end portion of a succeeding electrode foil. In the foil connection portion by the foil connection operation, there may be a section in which the coating operation is temporarily stopped while the foil connection portion passes through the coating device such that the coating operation is not performed.

Since the coating is not performed during a pause section of the coating operation, the foil connection portion may not be coated. In this case, a drying process performed after the coating process may be continuously performed regardless of the presence of the foil connection portion.

However, a general electrode drying device may perform a drying operation regardless of the presence of the foil connection portion. Accordingly, a foil uncoated portion, such as a foil connection portion of an electrode sheet without the coating portion, may be overdried (in a low humidity state), and accordingly, when the coating is resumed, a defect such as thermal wrinkles or electrode cracking may occur in a foil uncoated portion.

### SUMMARY

An aspect of the present disclosure is to provide an apparatus and a method for drying battery electrodes which may prevent overdrying in a dryer by temporarily stopping operation of an auxiliary heater portion, which is an auxiliary heat source among a main heat source and an auxiliary heat source disposed in the dryer, in a process of coating and drying a portion of an electrode foil of a battery while an uncoated foil connection portion of a coated electrode sheet, connected to a prior foil and a subsequent foil, enters and passes through the dryer.

According to an aspect of the present disclosure, an apparatus for drying a battery electrode includes a drying portion for drying a coated electrode sheet; an auxiliary heater portion disposed in the drying portion and configured to dry the coated electrode sheet; and a control unit configured to control turning-off driving of the auxiliary heater portion in response that a coating stop is initiated for a foil connection portion of an electrode sheet to be coated, in which a prior foil and a subsequent foil are connected to each other, and to control redriving of the auxiliary heater portion in response that the foil connection portion passes through the drying portion and a coating restart is initiated.

According to an aspect of the present disclosure, a method for drying a battery electrode performed in an apparatus for drying a battery electrode including a first drying portion including first to nth dryers for drying a coated electrode sheet, and an auxiliary heater portion including a first auxiliary heater portion to an nth auxiliary heater portion disposed in the first to nth dryers, respectively, includes a coating stop determination operation of determining, by the apparatus, whether to stop a coating operation for a foil connection portion of an electrode sheet to be coated, in which a prior foil and a subsequent foil are connected to each other, by the apparatus for drying a battery electrode; an auxiliary heater stop operation of controlling, by the apparatus, turning-off driving of the auxiliary heater portion by the apparatus for drying a battery electrode when the coating stop is determined; a coating restart determination operation of determining, by the apparatus, whether to restart coating after the foil connection portion passes through the first drying portion by the apparatus for drying a battery electrode; and an auxiliary heater restart operation of controlling, by the apparatus, redriving of the auxiliary heater portion by the apparatus for drying a battery electrode when the coating restart is determined.

### BRIEF DESCRIPTION OF DRAWINGS

Predetermined aspects, features, and advantages of the present disclosure are illustrated by the following detailed description with reference to the accompanying drawings.

FIG. 1 is a diagram illustrating an apparatus for drying a battery electrode according to an embodiment of the present disclosure;

FIG. 2 is a diagram illustrating configuration of an apparatus for drying a battery electrode according to an embodiment of the present disclosure;

FIG. 3 is a diagram illustrating a drying portion and auxiliary heater portion according to an embodiment of the present disclosure;

FIG. 4 is a diagram illustrating configuration of an apparatus for drying a battery electrode according to an embodiment of the present disclosure;

FIG. 5 is a diagram illustrating a drying portion according to an embodiment of the present disclosure;

FIG. 6 is a diagram illustrating an auxiliary heater portion according to an embodiment of the present disclosure;

FIG. 7 is a diagram illustrating a turning-off operation for an auxiliary heater portion according to an embodiment of the present disclosure;

FIG. 8 is a diagram illustrating a time point of a turning-off operation for an auxiliary heater portion according to an embodiment of the present disclosure;

FIG. 9 is a diagram illustrating reoperation for an auxiliary heater portion according to an embodiment of the present disclosure;

FIG. 10 is a diagram illustrating a time point of reoperation for an auxiliary heater portion according to an embodiment of the present disclosure;

FIG. 11 is a diagram illustrating configuration of a control unit according to an embodiment of the present disclosure;

FIG. 12 is a diagram illustrating operations of a method for drying a battery electrode according to an embodiment of the present disclosure;

FIG. 13 is an operation diagram illustrating an auxiliary heater stop operation according to an embodiment of the present disclosure;

FIG. 14 is an operation diagram illustrating an auxiliary heater restart operation according to an embodiment of the present disclosure;

FIG. 15 is a diagram illustrating specific operations of an auxiliary heater stop operation according to an embodiment of the present disclosure; and

FIG. 16 is a diagram illustrating specific operations of an auxiliary heater restart operation according to an embodiment of the present disclosure.

### DETAILED DESCRIPTION

The embodiments of the present disclosure are illustrated in embodiments with reference to the accompanying drawings.

In the drawings, same elements will be indicated by same reference numerals. Also, redundant descriptions and detailed descriptions of known functions and elements which may unnecessarily make the gist of the present disclosure obscure will not be provided. Even when the drawings illustrate components having the same reference number, the plurality of drawings do not refer to the same embodiment.

The present disclosure may have various modifications and various embodiments, and specific embodiments may be illustrated in detail in the drawings. However, this is not intended to limit the present disclosure to specific embodiments, but should be understood to include all modifications, equivalents, or substitutes included in the spirit and technical scope of the present disclosure.

The terms “first,” “second,” and the like may be used to distinguish one element from the other, and may not limit a sequence and/or an importance, or others, in relation to the elements. In some cases, a first element may be referred to as a second element, and similarly, a second element may be referred to as a first element without departing from the scope of right of the embodiments.

An expression used in the singular encompasses the expression of the plural, unless it has a clearly different meaning in the context. It should be understood that terms such as “include” or “have” are intended to specify the presence of a feature, number, step, operation, component, part, or combination thereof described in the specification, but do not exclude in advance the possibility of the presence or addition of one or more other features, numbers, steps, operations, components, parts, or combinations thereof.

Unless otherwise indicated, all terms used herein, including technical or scientific terms, have the same meaning as commonly understood by one of ordinary skill in the art to which the present disclosure belongs. Terms defined in commonly used dictionaries should be interpreted to be consistent with the context of the relevant art, and will not be interpreted in an idealized or overly formal sense unless expressly defined in this application.

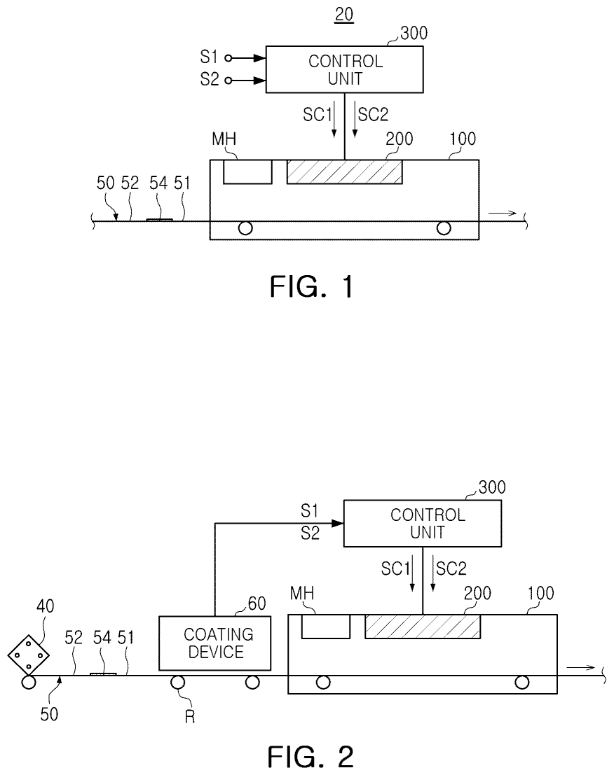

FIG. 1 is a diagram illustrating an apparatus for drying a battery electrode according to an embodiment.

Referring to FIG. 1, an apparatus 20 for drying a battery electrode according to an embodiment may include a drying portion 100, an auxiliary heater portion 200, and a control unit 300.

The drying portion 100 may be configured as a chamber for drying an electrode sheet 50 coated with an electrode material. For example, when a moving speed of the electrode sheet is low, the drying portion 100 may include only a main heater portion MH, which is a main heat source. However, when the moving speed of the electrode sheet is high depending on the electrode production speed, and the main heater portion MH alone is not sufficient, the auxiliary heater portion 200, which is an auxiliary heat source, may be included together with the main heater portion MH.

An electrode sheet 50, transported by a rotating roller R and moving in one direction by the auxiliary heater portion 200 together with the main heater portion MH disposed in the drying portion 100, may be dried while passing through the drying portion 100.

For example, the main heater portion MH may be implemented as a hot air blower, but an embodiment thereof is not limited thereto, and the auxiliary heater portion 200 may include an IR heater, but an embodiment thereof is not limited thereto.

The auxiliary heater portion 200 may be disposed in the drying portion 100 to dry the electrode sheet 50 coated with an electrode material, and may operate together with the main heater portion MH disposed in the drying portion 100.

The control unit 300 may control turning-off driving of the auxiliary heater portion 200 in response that a coating stop is initiated for the foil connection portion 54 in which the prior foil 51 and the subsequent foil 52 of the electrode sheet 50 to be coated are connected to each other (based on a coating stop signal S1), and may control redriving of the auxiliary heater portion 200 when a coating restart is initiated (based on a coating restart signal S2) after the foil connection portion 54 passes through the drying portion 100.

For example, the coating stop signal S1 and the coating restart signal S2 may be provided in the coating device, or may also be provided in the device controlling the coating, and thus, an example in which the signals are provided in the coating device will be described, but an embodiment thereof is not limited thereto.

For each drawing of the present disclosure, unnecessary redundant descriptions of the same symbol and the same functional components may not be provided, and differences may be described for each drawing.

In the present disclosure, the control unit 300 may be implemented as hardware or software in at least one integrated circuit (IC) embedded in the apparatus for drying a battery electrode, but an embodiment thereof is not limited thereto.

FIG. 2 is a diagram illustrating configuration of an apparatus for drying a battery electrode according to an embodiment.

Referring to FIG. 2, a coating device 60 may initiate a coating stop for the foil connection portion 54 of the electrode sheets 50 to be coated, connected to a prior foil 51 and a subsequent foil 52, and may output a coating stop signal S1 to the control unit 300. Also, the coating device 60 may initiate a coating restart after the foil connection portion 54 passes through the drying portion 100, and may output a coating restart signal S2 to the control unit 300.

When the control unit 300 receives a coating stop signal S1 for the foil connection portion 54 from the coating device 60, the control unit 300 may control turning-off driving of the auxiliary heater portion 200, and when the coating restart signal S2 is received from the coating device 60 after the foil connection portion 54 passes through the drying portion 100, the control unit 300 may control redriving of the auxiliary heater portion 200.

For coating and drying the continuous electrode sheet, an end of the prior foil 51, released from a winding portion of the turret 40 and moving through the roller R, may be connected to an end of the subsequent foil 52, which is released from the other winding portion of the turret 40 and moving through the roller R, by a foil connecting device.

In this case, when the foil connection portion 54 in which the prior foil 51 and the subsequent foil 52 are connected to each other is coated, a problem such as tearing of the foil connection portion may occur, such that the coating device 60 may be stopped for a while to stop the coating operation while the foil connection portion passes, and accordingly, the foil connection portion may not be coated. That is, the foil connection portion may be in an uncoated state.

The coating device 60 may perform coating by applying slurry, which is an electrode material, to a portion of the electrode sheet 50 being moved. For example, the slurry may be an electrode material applied to an electrode collector, and may be manufactured by dispersing an active material, conductive material, and binder in a solvent.

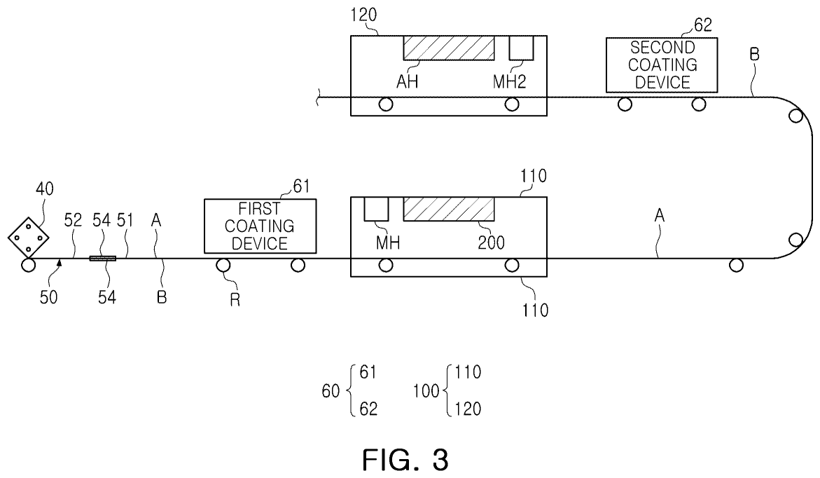

FIG. 3 is a diagram illustrating a drying portion and auxiliary heater portion according to an embodiment.

Referring to FIG. 3, the drying portion 100 may include a first drying portion 110 and a second drying portion 120.

For example, the first drying portion 110 may dry one surface A of the coated electrode sheet 50 by the first coating device 61. The second drying portion 120 may dry the other surface B of the coated electrode sheet 50 by the second coating device 62 after passing through the first drying portion 100.

The coating device 60 may include a first coating device 61 and a second coating device 62.

For example, the first coating device 61 may be disposed on the input side of the first drying portion 100 and may coat one surface A of the electrode sheet entering the first drying portion 100 with an electrode material. The second coating device 62 may be disposed on the input side of the second drying portion 150, and may coat the other surface B of the electrode sheet 50 entering the second drying portion 150 with an electrode material.

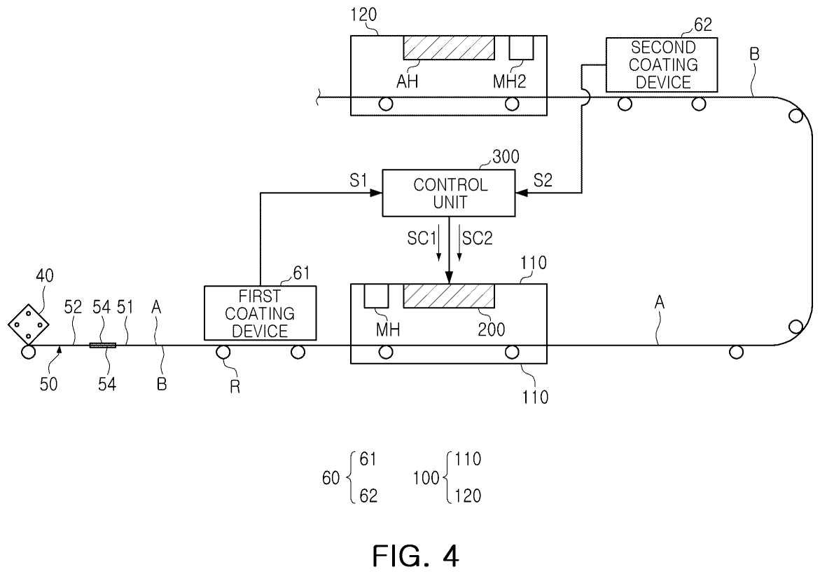

FIG. 4 is a diagram illustrating configuration of an apparatus for drying a battery electrode according to an embodiment.

Referring to FIG. 4, a control unit 300 may control turning-off driving of the auxiliary heater portion 200 when a coating stop signal S1 for the foil connection portion 54 is received from the first coating device 61, and may control redriving of the auxiliary heater portion 200 when a coating restart signal S2 is received from the second coating device 62 after the foil connection portion 54 passes through the first drying portion 100.

For example, the coating stop signal S1 and the coating restart signal S2 may be provided from the first coating device 61 and the second coating device 62, or may also be provided from a device controlling coating. Thus, in the present disclosure, an example in which the signals are provided from the coating device may be described, but an embodiment thereof is not limited thereto.

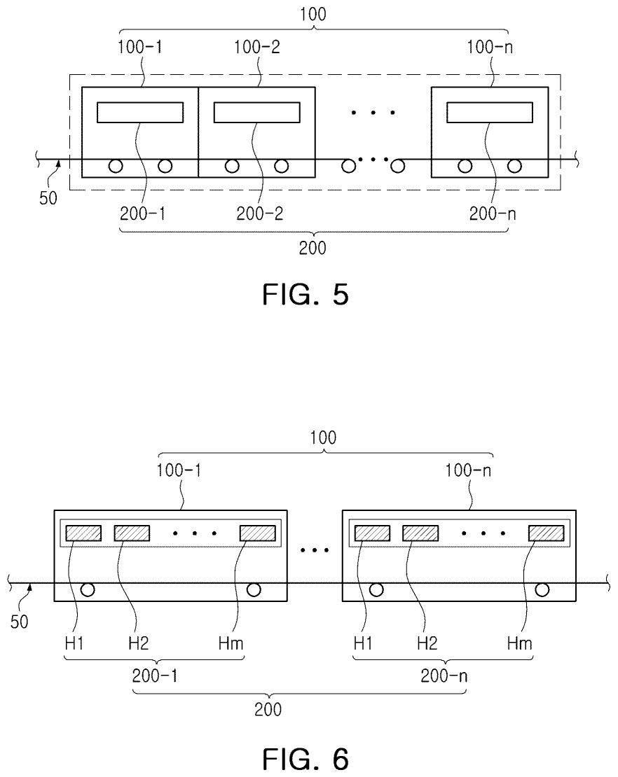

FIG. 5 is a diagram illustrating a drying portion according to an embodiment.

Referring to FIG. 5, the first drying portion 110 may include a first dryer 110-1, and a second dryer 110-2 to an nth dryer 110-n (where n is a natural number greater than or equal to 3).

The first dryer 110-1, and the second dryer 110-2 to the nth dryer 110-n may be connected to each other in series for sufficient drying of the electrode sheet, and may dry the moving electrode sheet 50 having coated in the first coating device 61 and brought into the drying portion 100 by the roller R.

Also, the auxiliary heater portion 200 may include a first auxiliary heater portion 200-1, and a second auxiliary heater portion 200-2 to an nth auxiliary heater portion 200-n, respectively.

For example, the first auxiliary heater portion 200-1, and the second auxiliary heater portion 200-2 to the nth auxiliary heater portion 200-n may be installed in a first dryer 110-1 to a nth dryer 110-n, respectively. For example, the first auxiliary heater portion 200-1 may be installed in the first dryer 110-1, the second auxiliary heater portion 200-2 may be installed in the second dryer 110-2, and the nth auxiliary heater portion 200-n may be installed in the nth dryer 110-n.

FIG. 6 is a diagram illustrating an auxiliary heater portion according to an embodiment.

Referring to FIG. 6, for example, each of the first auxiliary heater portion 200-1 to the nth auxiliary heater portion 200-n may include a plurality of auxiliary heaters H1-Hm.

For example, in FIG. 6, the first auxiliary heater portion 200-1 to the nth auxiliary heater portion 200-n may include the same number of auxiliary heaters H1-Hm, but an embodiment thereof is not limited thereto, and a different number of auxiliary heaters may be included.

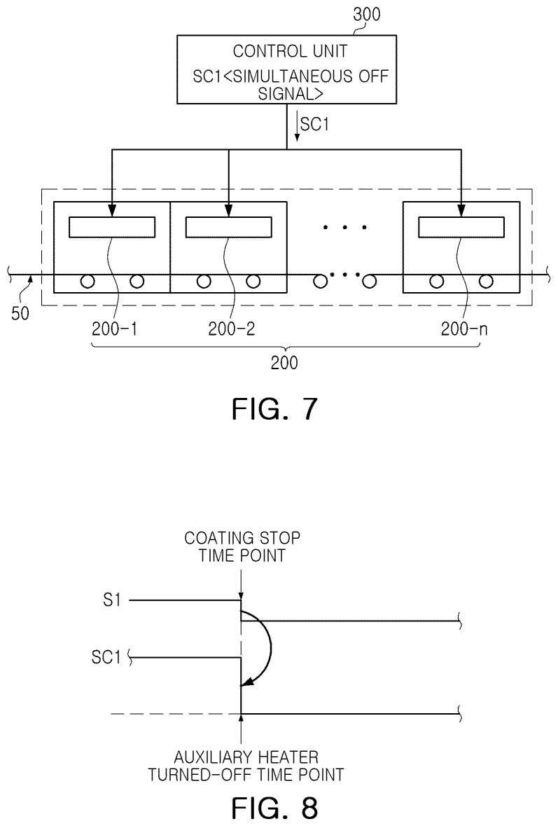

FIG. 7 is a diagram illustrating a turning-off operation for an auxiliary heater portion according to an embodiment. FIG. 8 is a diagram illustrating a time point of a turning-off operation for an auxiliary heater portion according to an embodiment.

Referring to FIG. 7 and FIG. 8, a control unit 300 may control a first auxiliary heater portion 200-1 to an nth auxiliary heater portion 200-n of the auxiliary heater portion 200, which are in a turned-on state, to be in a turned-off state simultaneously using a first control signal SC1 when a coating stop signal S1 is received.

Referring to FIG. 8, for example, the control unit 300 may generate the first control signal SC1 synchronized with the coating stop signal S1, and simultaneously output the first auxiliary heater portion 200-1 to the nth auxiliary heater portion 200-n to be turned off simultaneously.

For example, in the present disclosure, the coating stop time point of the coating stop signal S1 may indicate a time point at which the signal is transitioned from a high level to a low level, and the auxiliary heater off time point of the first control signal SC1 may indicate a time point at which the signal is transitioned from a high level to a low level.

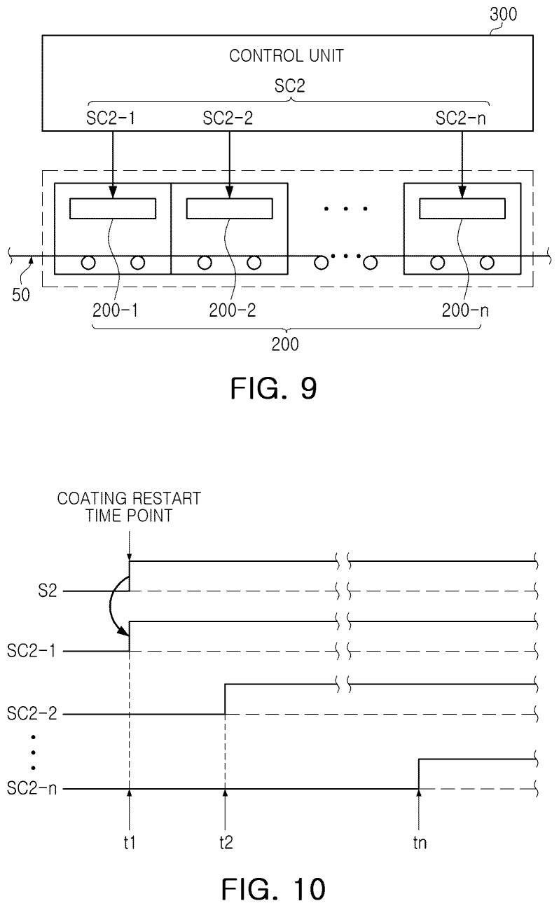

FIG. 9 is a diagram illustrating reoperation for an auxiliary heater portion according to an embodiment. FIG. 10 is a diagram illustrating a time point of reoperation for an auxiliary heater portion according to an embodiment.

Referring to FIG. 9, when a control unit 300 receives a coating restart signal S2, the control unit 300 may control first to nth auxiliary heater portions 200-1 to 200-n, which are in a turned-off state, to be sequentially in a turned-on state with a predetermined time interval using the second control signal SC2.

Referring to FIG. 10, for example, the control unit 300 may generate the second control signal SC2 synchronized with the coating restart signal S2, and the second control signal SC2 may generate the first restart signal SC2-1, and the second restart signal SC2-2 to the nth restart signal SC2-n, which have sequential restart time points with a predetermined time interval.

For example, to restart with a predetermined time interval, the first restart signal SC2-1, and the second restart signal SC2-2 to the nth restart signal SC2-n may be applied to the first auxiliary heater portion 200-1, and the second auxiliary heater portion 200-2 to the nth auxiliary heater portion 200-n, respectively.

For example, when a restart time point of each of the first restart signal SC2-1, the second restart signal SC2-2 to the nth restart signal SC2-n is described, the control unit 300 may generate the first restart signal SC2-1 having a restart time point at t1 second (e.g., 0 second: immediately) from a coating restart time point of the coating restart signal S2, may generate the second restart signal SC2-2 having a restart time point at t2 seconds (e.g., 48 seconds) later from a coating restart time point of the coating restart signal S2, and may generate the nth restart signal SC2-n having a restart time point at tn seconds (e.g., 88 seconds when n is 4) later from a coating restart time point of the coating restart signal S2.

For example, in the present disclosure, a restart time point of the coating restart signal S2 may indicate a time point of transition from a low level to a high level, and a restart time point of each of the first restart signal SC2-1 to the nth restart signal SC2-n of the second control signal SC2 may indicate a time point of transition from a low level to a high level, and the description of the level transition direction (the transition direction from a high level to a low level or the transition direction from a low level to a low level) is merely an example, but an embodiment thereof is not limited thereto.

In the present disclosure, the example in which the high level and the low level are logic <H> and logic <L>, respectively, but an embodiment thereof is not limited thereto, and the logic levels of the signals are not limited to the examples.

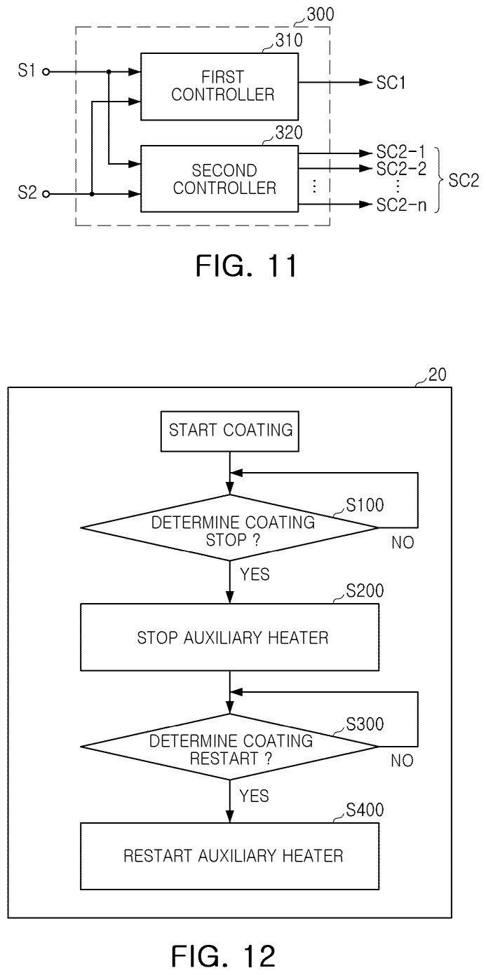

FIG. 11 is a diagram illustrating configuration of a control unit according to an embodiment.

Referring to FIG. 11, the control unit 300 may include a first controller 310 and a second controller 320.

When the coating stop signal S1 is received, the first controller 310 may generate a first control signal SC1 for simultaneously controlling driving of the first auxiliary heater portion 200-1 to the nth auxiliary heater portion 200-n of the auxiliary heater portion 200 to be turned off, and may output the first control signal SC1 to each of the first auxiliary heater portion 200-1 to the nth auxiliary heater portion 200-n simultaneously. For example, the first controller 310 may include a first signal generator for generating the first control signal SC1.

When the coating restart signal S2 is received, the second controller 320 may generate a second control signal SC2 including first to nth driving turn-on signals SC2-1 to SC2-n for controlling redriving of the first auxiliary heater portion 200-1 to the nth auxiliary heater portion 200 of the auxiliary heater portion 200 at a predetermined time interval and may output the second control signal SC2 to each of the first auxiliary heater portion 200-1 to the nth auxiliary heater portion 200-n of the auxiliary heater portion 200. For example, the first controller 310 may include a second signal generator for generating the second control signal SC2.

Also, the first controller 310 and the second controller 320 of the control unit 300 may be implemented as individual processors or as an integrated processor, but not limited thereto.

Hereinafter, referring to FIG. 12 and FIG. 16, a method for drying a battery electrode may be described. In the present disclosure, the description of the method for drying a battery electrode and the description of the apparatus for drying a battery electrode may be applied complementarily or commonly, unless otherwise indicated.

FIG. 12 is a diagram illustrating operations of a method for drying a battery electrode according to an embodiment.

The method for drying a battery electrode according to an embodiment illustrated in FIG. 12 may be performed in the apparatus 20 for drying a battery electrode described with reference to FIGS. 1 to 11.

Referring to FIGS. 1 and 12, the method for drying a battery electrode according to an embodiment may include a coating stop determination operation S100, an auxiliary heater stop operation S200, a coating restart determination operation (S300), and an auxiliary heater restart operation (S400).

For example, in the coating stop determination operation S100, the apparatus 20 for drying a battery electrode may determine whether to stop a coating operation for the foil connection portion 54 of the electrode sheets 50 to be coated, in which a prior foil 51 and a subsequent foil 52 are connected to each other.

In the auxiliary heater stop operation S200, the apparatus 20 for drying a battery electrode may control turning-off driving of the auxiliary heater portion 200 when the coating stop is determined.

In the coating restart determination operation (S300), the apparatus 20 for drying a battery electrode may determine whether to restart the coating after the foil connection portion 54 passes through the first drying portion 100.

In the auxiliary heater restart operation (S400), the apparatus 20 for drying a battery electrode may control redriving of the auxiliary heater portion 200 when the coating restart is determined.

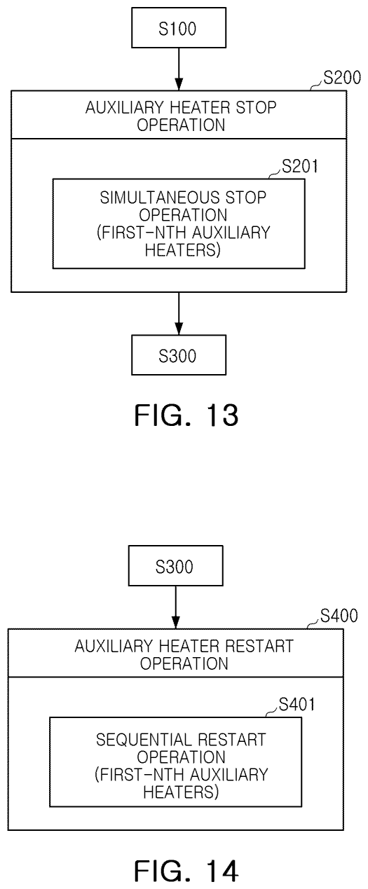

FIG. 13 is an operation diagram illustrating an auxiliary heater stop operation according to an embodiment.

Referring to FIG. 1 and FIG. 13, the auxiliary heater stop operation S200 may include a simultaneous stop operation S201 for the first auxiliary heater portion 200-1 to the nth auxiliary heater portion 200-n of the auxiliary heater portion 200.

For example, in the simultaneous stop operation S201, the apparatus 20 for drying a battery electrode may control the first auxiliary heater portion 200-1 to the nth auxiliary heater portion 200-n of the auxiliary heater portion 200, which are in a turned-on state, to be in a turned-off state simultaneously when the coating stop signal S1 is received.

FIG. 14 is an operation diagram illustrating an auxiliary heater restart operation according to an embodiment.

Referring to FIG. 1 and FIG. 14, the auxiliary heater restart operation (S400) may include a sequential restart operation (S01).

For example, in the sequential restart operation (S01), the apparatus 20 for drying a battery electrode may control the first to nth auxiliary heater portions 200-1-200-n, which are in a turned-off state, to be sequentially in a turned-on state with a predetermined time interval when the coating restart signal S2 is received.

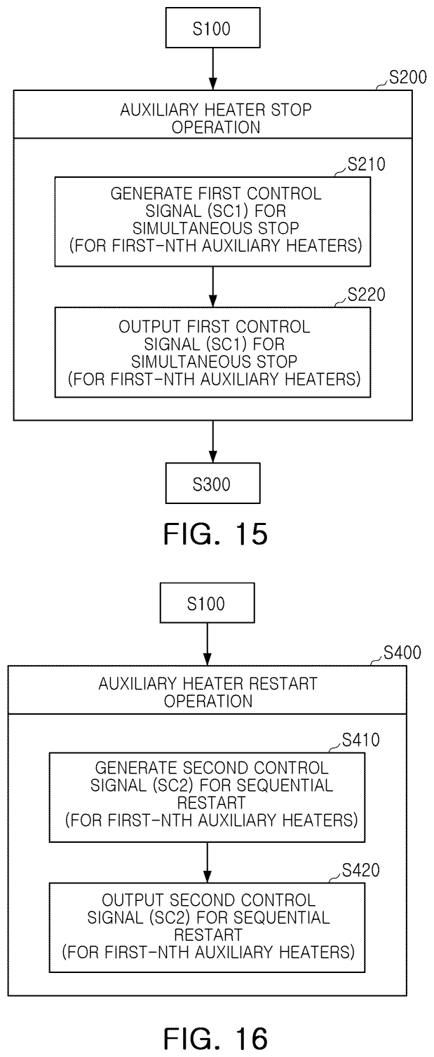

FIG. 15 is a diagram illustrating specific operations of an auxiliary heater stop operation according to an embodiment.

Referring to FIG. 1 and FIG. 15, the auxiliary heater stop operation (S200) may include an operation of generating a first control signal for simultaneous stop (S210) and an operation of outputting a first control signal for simultaneous stop (S220).

For example, in the operation of generating a first control signal for simultaneous stop (S210), the apparatus 20 for drying a battery electrode may generate the first control signal SC1 for controlling turning-off driving of the first auxiliary heater portion 200-1 to the nth auxiliary heater portion 200-n of the auxiliary heater portion 200 installed in the first drying portion 100 simultaneously when the coating stop is determined.

In the operation of outputting a first control signal for simultaneous stop (S220), the apparatus 20 for drying a battery electrode may output the first control signal SC1 of the first auxiliary heater portion 200-1 to the nth auxiliary heater portion 200-n of the auxiliary heater portion 200 simultaneously.

FIG. 16 is a diagram illustrating specific operations of an auxiliary heater restart operation according to an embodiment.

Referring to FIG. 1 and FIG. 16, the auxiliary heater restart operation (S400) may include an operation of generating, by the apparatus, a second control signal for sequential restart (S410) and an operation of outputting, by the apparatus, a second control signal for sequential restart (S420).

For example, in the operation of generating a second control signal for sequential restart (S410), the apparatus 20 for drying a battery electrode may generate a second control signal SC2 including first to nth driving turn-on signals SC2-1 to SC2-n for controlling redriving of a first auxiliary heater portion 200-1 to an nth auxiliary heater portion 200-n of the auxiliary heater portion 200 with a predetermined time interval when a coating restart is determined.

In the operation of outputting a second control signal for sequential restart (S420), the apparatus 20 for drying a battery electrode may output a second control signal SC2 including the first to nth driving turn-on signals SC2-1-SC2-n to the first auxiliary heater portion 200-1 to nth auxiliary heater portion 200-n of the auxiliary heater portion 200, respectively.

According to the aforementioned embodiments, by stopping the operation of the auxiliary heater portion, which is an auxiliary heat source among the main heat source and the auxiliary heat source disposed in the dryer, while the uncoated foil connection portion of the coated electrode sheet, in which the prior foil and the subsequent foil are connected to each other in the process of coating a portion of an electrode foil of a battery, enters and passes through the dryer, overdrying in the dryer may be prevented, and accordingly, a defect occurring in the uncoated portion of the electrode sheet may be prevented in advance.

Only specific examples of implementations of predetermined embodiments are described. Variations, improvements and enhancements of the disclosed embodiments and other embodiments may be made with respect to the disclosure of this patent document.

What is claimed is:

1. An apparatus for drying a battery electrode, the apparatus comprising:
a drying portion for drying a coated electrode sheet;
an auxiliary heater portion disposed in the drying portion and configured to dry the coated electrode sheet; and
a control unit configured to control turning-off driving of the auxiliary heater portion in response that a coating stop is initiated for a foil connection portion of an electrode sheet to be coated, in which a prior foil and a subsequent foil are connected to each other, and to control redriving of the auxiliary heater portion in response that the foil connection portion passes through the drying portion and a coating restart is initiated.

2. The apparatus of claim 1, wherein the control unit controls turning-off driving of the auxiliary heater portion when a coating stop signal for the foil connection portion is received from a coating device, and controls redriving of the auxiliary heater portion in response that the foil connection portion passes through the drying portion and a coating restart signal is received from the coating device.

3. The apparatus of claim 2, wherein the drying portion includes:
a first drying portion for drying one surface of the coated electrode sheet; and
a second drying portion for drying the other surface of the coated electrode sheet through the first drying portion.

4. The apparatus of claim 3, wherein the control unit controls turning-off driving of the auxiliary heater portion when a coating stop signal for the foil connection portion is received from the first coating device, and controls redriving of the auxiliary heater portion in response that the foil connection portion passes through the first drying portion and a coating restart signal is received from a second coating device.

5. The apparatus of claim 3, wherein the first drying portion includes a first dryer, and a second dryer to an nth dryer, connected to each other, to dry the coated electrode sheet.

6. The apparatus of claim 2, wherein the auxiliary heater portion includes a first auxiliary heater portion, and a second auxiliary heater portion to an nth auxiliary heater portion, installed in the first dryer to the nth dryer, respectively.

7. The apparatus of claim 2, wherein each of the first auxiliary heater portion to the nth auxiliary heater portion includes a plurality of auxiliary heaters.

8. The apparatus of claim 6, wherein the control unit controls the first auxiliary heater portion to the nth auxiliary heater portion of the auxiliary heater portion, which are in a turned-on state, to be in a turned-off state simultaneously when the coating stop signal is received.

9. The apparatus of claim 6, wherein the control unit controls the first to nth auxiliary heater portions, which are in turned-off state, to be sequentially in a turned-on state with a predetermined time interval when the coating restart signal is received.

10. The apparatus of claim 6, wherein the control unit includes:
a first controller configured to generate, when the coating stop signal is received, a first control signal for controlling driving of the first auxiliary heater portion to the nth auxiliary heater portion of the auxiliary heater portion to be turned off simultaneously, and to output the first control signal to each of the first auxiliary heater portion to the nth auxiliary heater portion; and
a second controller configured to generate, when the coating restart signal is received, a second control signal including first to nth driving signals for controlling redriving of the first auxiliary heater portion to the nth auxiliary heater portion of the auxiliary heater portion at a predetermined time interval and to output the second control signal to each of the first auxiliary heater portion to the nth auxiliary heater portion of the auxiliary heater portion.

11. A method for drying a battery electrode performed in an apparatus for drying a battery electrode including a first drying portion including first to nth dryers for drying a coated electrode sheet, and an auxiliary heater portion including a first auxiliary heater portion to an nth auxiliary heater portion disposed in the first to nth dryers, respectively, the method comprising:
a coating stop determination operation of determining, by the apparatus, whether to stop a coating operation for a foil connection portion of an electrode sheet to be coated, in which a prior foil and a subsequent foil are connected to each other, by the apparatus for drying a battery electrode;
an auxiliary heater stop operation of controlling, by the apparatus, turning-off driving of the auxiliary heater portion by the apparatus for drying a battery electrode when the coating stop is determined;
a coating restart determination operation of determining, by the apparatus, whether to restart coating after the foil connection portion passes through the first drying portion by the apparatus for drying a battery electrode; and
an auxiliary heater restart operation of controlling, by the apparatus, redriving of the auxiliary heater portion by the apparatus for drying a battery electrode when the coating restart is determined.

12. The method of claim 11, wherein the auxiliary heater stop operation includes controlling the first auxiliary heater portion to the nth auxiliary heater portion of the auxiliary heater portion, which are in a turned-on state, to be in a turned-off state simultaneously when a coating stop signal is received.

13. The method of claim 11, wherein the auxiliary heater restart operation includes controlling the first to nth auxiliary heater portions, which are in a turned-off state, to be sequentially in a turned-on state with a predetermined time interval when a coating restart signal is received.

14. The method of claim 11, wherein the auxiliary heater stop operation includes:
an operation of generating, by the apparatus, a first control signal for simultaneous stop, the operation of generating a first control signal for controlling driving of the first auxiliary heater portion to the nth auxiliary heater portion of the auxiliary heater portion installed in the first drying portion to be turned off simultaneously when the coating stop is determined; and
an operation of outputting, by the apparatus, a first control signal for simultaneous stop, the operation of simultaneously outputting the first control signal to the first auxiliary heater portion to the nth auxiliary heater portion.

15. The method of claim 11, wherein the auxiliary heater restart operation includes:
an operation of generating, by the apparatus, a second control signal for sequential restart, the operation of generating a second control signal including first to nth driving turn-on signals for controlling redriving of the first auxiliary heater portion to the nth auxiliary heater portion of the auxiliary heater portion at a predetermined time interval when a coating restart is determined; and
an operation of outputting, by the apparatus, a second control signal for sequential restart, the operation of outputting a second control signal including first to nth driving turn-on signals to the first auxiliary heater portion to the nth auxiliary heater portion of the auxiliary heater portion, respectively.
